(19) United States
(12) Patent Application Publication
(10) Pub. No.: US 2012/0241535 A1
(43) Pub. Date: Sep. 27, 2012

(54) WATER ATOMIZATION AND MIST DELIVERY SYSTEM

(75) Inventors: Thierry Carriere, Littleton, CO (US); Scott Merkley, Louisville, CO (US); Norm Haberkorn, Parker, CO (US); James Butz, Lakewood, CO (US); Andrew Brewer, Golden, CO (US)

(73) Assignee: ADA TECHNOLOGIES, INC., Littleton, CO (US)

(21) Appl. No.: 13/426,366

(22) Filed: Mar. 21, 2012

Related U.S. Application Data
(60) Provisional application No. 61/454,875, filed on Mar. 21, 2011.

(51) Int. Cl. B05B 7/06

(52) U.S. Cl. 239/8; 239/425.5

(57) ABSTRACT

The present disclosure is directed, in one embodiment, to a water atomization and water mist delivery system in which water and a gas are mixed in an aspirating device and provided to a nozzle. The mixture may be delivered from the nozzle to provide fire protection and suppression.

### CROSS REFERENCE TO RELATED APPLICATION

The present application claims the benefits of U.S. Provisional Application Ser. No. 61/454,875, filed Mar. 21, 2011, entitled “Water Atomization and Mist Delivery Assembly”, which is incorporated herein by this reference in its entirety.

Cross reference is made to U.S. patent application Ser. No. 11/875,494 filed Oct. 19, 2007 entitled “Fine Water Mist Multiple Orientation Discharge Fire Extinguisher” which is incorporated herein by this reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. FA4819-10-C-0026 awarded by the U.S. Air Force.

### FIELD

The disclosure relates generally to water atomization and water mist delivery technologies and particularly to water atomization and water mist delivery for fire protection and suppression.

### BACKGROUND

Atomized liquids and methods of delivery have many applications, spanning water evaporation, fuel combustion, humidifiers, snow making, powder metal fabrication and fire protection and suppression. An atomized liquid may be narrowly defined as a liquid reduced or separated into atoms, but more broadly defined as a liquid broken into fine particles or fine drops. Atomized water may be referred to as a fine water mist (FWM). Devices and methods for generating and delivering atomized liquids vary widely. Means for atomizing a liquid include vibration, shock waves, pressure expansion and ultrasound, and frequently employ a nozzle.

Atomized water and/or fine water mist has been found to be particularly well-suited in fire suppression applications. In fire suppression applications, atomized water more efficiently lowers flame temperature than liquid water. Chemicals can be used to supplement or replace water and to inhibit or interrupt a fire's combustion processes. However, most chemicals employed for fire suppression suffer from environmental difficulties. For example, halon and/or hydrochlorofluorocarbons (HCFCs) were developed and deployed for fire suppression, but were subsequently banned from use and production under the 1989 Montreal Protocol. For example, the USAF is planning to retire the currently installed Halon 1301 fire protection systems from hush houses and replace them with an environmentally friendly solution. Due to its high ozone depletion potential, Halon 1301 is no longer manufactured and existing installations are being progressively phased out. Replacement of Halon 1301 has spawned numerous research activities in the past 15 years to identify one or several viable replacements. FWM is one of the possible technologies under consideration. Environmentally friendly drop-in replacements for fire suppression systems have been sought, but the search has yielded mixed results in terms of efficacy and volume.

FWM is viewed as a promising alternative to halons from both technical and environmental standpoints. Fine water mist can suppress fires by attacking all three legs of the “fire triangle”: heat, radiation, and fuel source. Water mist can take away heat from the fire as both sensible and latent heat. Perhaps surprisingly, research has shown that the sensible heat effects of water are as significant as the latent heat. However, the heat of vaporization is still important in removing energy from the fire. The steam produced can then act as an inerting agent, or diluent, to inhibit fire propagation. Finally, water mist can act to wet surfaces, which reduces the volatilization of solids and thus the amount of fuel present. An additional mechanism by which water mist can inhibit fires is through the attenuation of infrared radiation. A water aerosol becomes an optically dense medium that prevents the infrared heating of unburned surfaces by burning surfaces. Also, the nitrogen gas used in the generation and propulsion of the fine water mist displaces the oxygen, thereby removing a combustion component from the fire. FWM has remarkable thermal management and rapid knock down capabilities for large class B fires and thus provides great advantages not offered by gases. Also, FWM has been found to be very desirable to protect heat sensitive aircraft components and materials. Another advantage of FWM is its ability to maintain safe space occupancy during a fire event without the need to evacuate and secure the building. Finally, FWM also works well in spaces where compartment boundaries have been damaged, whereas gaseous agents need a well-sealed enclosure to maintain safety.

However, FWM has traditionally been viewed as too expensive to successfully implement, due to large degree by the difficulties of engineering a system that reliably generates and delivers a fine water mist at sufficient throw distances for effective fire suppression. To date, the use of FWM and/or atomized water for various applications, such as fire suppression, has been limited by complex mixing devices and nozzles with limited effective range. Important design criterion for fine water mist devices include the droplet properties of size and momentum, which are in large part controlled by the atomizer/nozzle design. In one typical configuration of the prior art, high pressure water is pumped through a single nozzle designed to break the surface tension in the liquid by shear force or centrifugal force, therein emitting atomized water. Such configurations require water pressures commonly exceeding 2000 psi and deliver a water mist of inconsistent quality. A mist delivery system, such as a fire suppression system, requiring such high pressures carries increased cost and decreased safety. Another typical configuration of the prior art uses a nozzle which combines supplied water with a gas at or near the nozzle exit, so as to break up the water as it exits the nozzle.

There is a need for a device and method of practically and reliably producing atomized water by combining water and gas in an aspirating device in communication with a nozzle. Such a device and method may be used, for example, to project a fine water mist at sufficient throw distances to effectively and practically provide fire suppression.

### SUMMARY

These and other needs are addressed by the various embodiments and configurations of the present disclosure. The present disclosure is directed to a water atomization and water mist delivery system in which water and a gas are mixed in an aspirating device and provided to a nozzle. The mixture may be delivered from the nozzle to provide fire protection and suppression.

In a first embodiment, a device for delivering a water mist includes the components:

(a) an aspirating device configured to receive a liquid and a gas, the liquid passing through a central passageway of the aspirating device and the gas entering the central passageway through one or more ports in the central passageway, wherein the liquid and gas are mixed to form an atomized liquid upon exit from the aspirating device; and

(b) a nozzle configured with one or more orifices, the nozzle in downstream communication with the aspirating device and configured to receive the atomized liquid, wherein the nozzle is configured to direct the atomized liquid through the one or more orifices to the exterior of the nozzle.

In another embodiment, a device for delivering a water mist includes the following additional components downstream of the aspirating device and upstream of the nozzle:

a carrier tube configured to receive atomized liquid from the aspirating device, wherein upon exit from the carrier tube the atomized liquid is a partially atomized liquid, and

a re-mixer configured to receive the partially atomized liquid, wherein upon exit from the re-mixer the partially atomized liquid is an atomized liquid supplied to the nozzle.

In another embodiment, a system comprises:

a gas input to receive a gas from a gas source;

a liquid input to receive a liquid from a liquid source;

a sensor operable top detect a thermal event;

a controller operable to cause discharge of the gas through the gas source and liquid through the liquid source;

an aspirating device configured to receive a liquid and a gas, the liquid passing through a central passageway of the aspirating device and the gas entering the central passageway through one or more ports in the central passageway, wherein the liquid and gas are mixed to form an atomized liquid upon exit from the aspirating device; and

a nozzle configured with one or more orifices, the nozzle in downstream communication with the aspirating device and configured to receive the atomized liquid, wherein the nozzle is configured to direct the atomized liquid through the one or more orifices to the exterior of the nozzle.

In one embodiment, a method includes the steps:

(a) providing an aspirating device configured to receive a liquid and a gas, the liquid passing through a central passageway of the aspirating device and the gas entering the central passageway through one or more ports in the central passageway, wherein the liquid and gas are mixed to form a atomized liquid upon exit from the aspirating device, a nozzle configured with one or more orifices, the nozzle in communication with the aspirating device and configured to receive the atomized liquid; and

(b) discharging the atomized liquid through the one or more orifices of the nozzle in proximity to an exothermic event, whereby the exothermic event is suppressed.

The aspirating device may be configured as an aspirating venturi in which the liquid flows through a throat of the venturi and the gas enters the throat of the venturi. The liquid may be water and the gas may be nitrogen.

The present disclosure can provide a number of advantages depending on the particular configuration. For example, the disclosed embodiments can use an effervescent means to produce atomized water without the high pressures required of the prior art. There is a need for a device and method of practically and reliably producing atomized water by combining water and gas in an aspirating device in communication with a nozzle. Such a device and method may be used, for example, to project a fine water mist at sufficient throw distances to effectively and practically provide fire suppression. In short, the embodiments can extinguish an exothermic event from a longer throw distance quicker, safer and more economically than traditional fine water mist and/or water atomization devices and methods.

These and other advantages will be apparent from the disclosure contained herein.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “aerosol” means a colloid suspension of fine solid particles or liquid droplets in a gas.

The term “aspirate” means to draw in or suction as enabled by a pressure differential.

The term “atomized liquid” means a liquid broken into fine particles or fine drops.

The term “atomized water” means water broken into fine particles or fine drops.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “deflagration” refers to a subsonic combustion that usually propagates through thermal conductivity (for example a hot burning material heats adjacent cold material and ignites it). In a deflagration, the combustion of a combustible gas, or other combustible substance, initiates a chemical reaction that propagates outwardly by transferring heat and/or free radicals to adjacent molecules of the combustible gas. A free radical is any reactive group of atoms containing unpaired electrons, such as OH, H, and CH₃. The transfer of heat and/or free radicals ignites the adjacent molecules. In this manner, the deflagration propagates or expands outwardly through the combustible gas generally at velocities typically ranging from about 0.2 ft/sec to about 20 ft/sec. The heat generated by the deflagration generally can cause a rapid pressure increase in confined areas. Deflagration is different from detonation (which is supersonic and propagates through shock compression).

The terms “determine”, “calculate” and “compute,” and variations thereof, as used herein, are used interchangeably and include any type of methodology, process, mathematical operation or technique.

The term “effervescent atomizer” means an atomizer where the gas is introduced directly into the flowing liquid, upstream of the nozzle.

The term “effervescent flow” means a two-phase bubbly flow generated by an effervescent atomizer.

The term “exothermic event” refers to any exothermic event, including without limitation fires, detonations, and deflagrations, and also to the creation or presence of conditions conducive to a fire, detonation, or deflagration

The term “explosion” refers to a rapid increase in volume and rapid release of energy, to include detonations and deflagrations.

The term “fire” refers to a rapid, persistent chemical change that releases heat and light and is accompanied by flame, especially the exothermic oxidation of a combustible substance.

The term “exothermic event retardant” refers to any substance that suppresses an exothermic process by one or more of cooling, forming a protective layer, diluting molecular oxygen concentration, chemical reactions in the gas phase, chemical reactions in the solid phase, char formation, and/or intumescents.

The term “high pressure system” refers to a water mist system where the distribution system piping is exposed to pressures of 34.5 bar (500 psi) or greater.

The term “intermediate pressure system” refers to a water mist system where the distribution system piping is exposed to pressures greater than 12.1 bar (175 psi) but less than 34.5 bar (500 psi).

The term “low pressure system” refers to a water mist system where the distribution system piping is exposed to pressures of 12.1 bar (175 psi) or less.

The term “module” refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “water mist” and “fine water mist” refer to a water spray for which the Dν_{0.99}, for the flow-weighted cumulative volumetric distribution of water droplets, is less than 1000 microns at the minimum design operating pressure of the water mist nozzle and/or device.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

FIG. 1A is a perspective view of the water atomization device according to a first embodiment;

FIG. 1B is a side view of the water atomization device according to a first embodiment;

FIG. 1C is a cross-sectional view of the water atomization device according to a first embodiment;

FIG. 2 is a disassembled view of the water atomization device according to a first embodiment;

FIG. 3A is a perspective view of the aspirating device subassembly of the first embodiment;

FIG. 3B is a side view of the aspirating device subassembly of the first embodiment;

FIG. 3C is a cross-sectional view of the aspirating device subassembly of the first embodiment taken along cut line A-A of FIG. 3B;

FIG. 4A is a perspective view of the nozzle subassembly of the first embodiment;

FIG. 4B is a perspective view of the nozzle subassembly of a second embodiment;

FIG. 4C is a perspective view of the nozzle subassembly of a third embodiment;

FIG. 5A is a top view of the nozzle subassembly of a second embodiment;

FIG. 5B is a side view of the nozzle subassembly of a second embodiment;

FIG. 5C is a cross-sectional view of the nozzle subassembly of a second embodiment taken along cut line A-A of FIG. 5B;

FIG. 5D is an alternate side view of the nozzle subassembly of a second embodiment;

FIG. 5E is a cross-sectional view of the nozzle subassembly of a second embodiment taken along cut line B-B of FIG. 5D;

FIG. 6A is a perspective view of the remixing subassembly of a fourth embodiment;

FIG. 6B is a top view of the remixing subassembly of a fourth embodiment;

FIG. 6C is a side view of the remixing subassembly of a fourth embodiment;

FIG. 6D is a cross-sectional view of the remixing subassembly of a fourth embodiment taken along cut line A-A of FIG. 6C;

FIG. 7A is a schematic of the water atomization device according to the first embodiment;

FIG. 7B is a schematic of the water atomization device according to the fourth embodiment; and

FIG. 8 is a schematic of the water atomization device according to a fifth embodiment.

### DETAILED DESCRIPTION

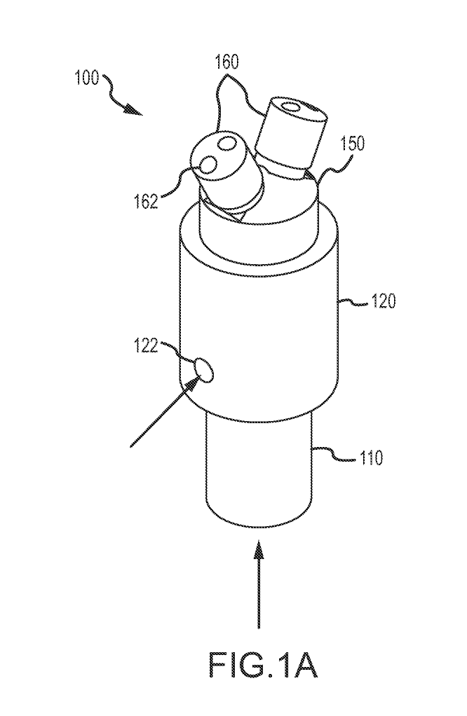

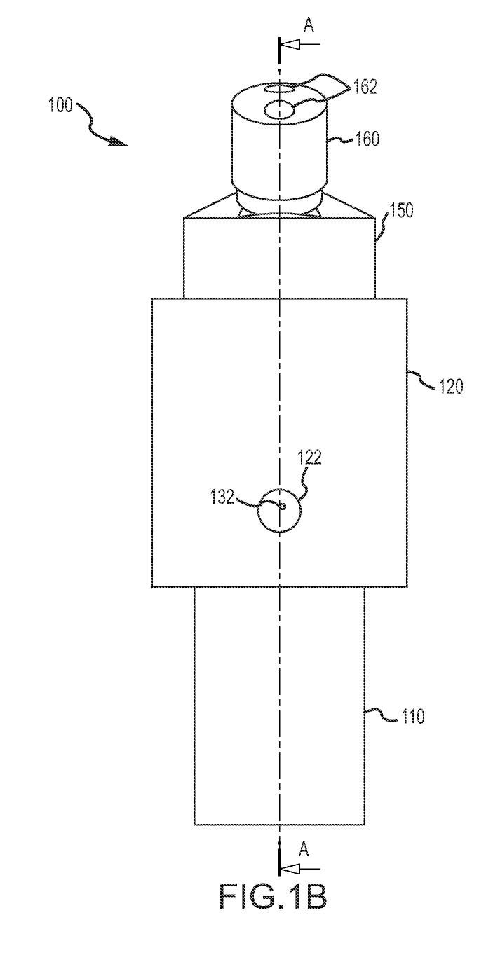

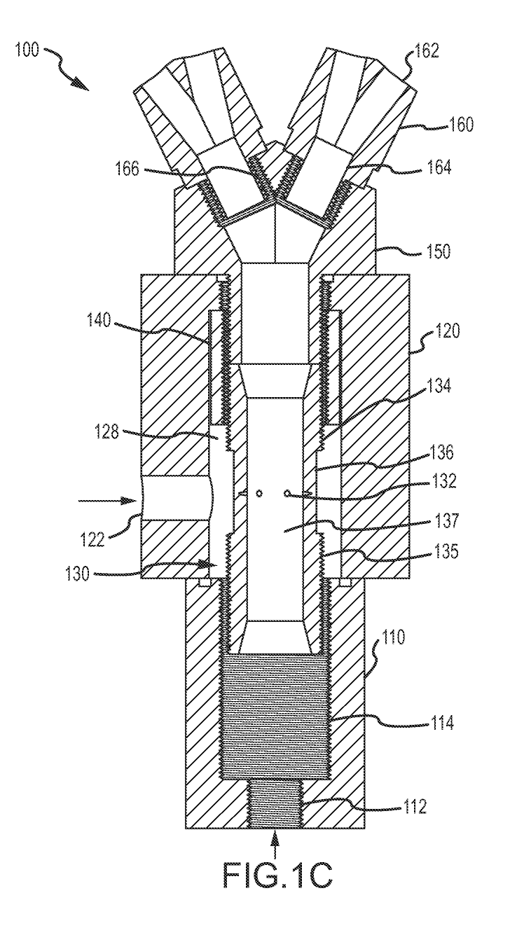

FIGS. 1A-C depict a water atomization device 100 according to a first embodiment. The water atomizer 100 includes a water connector 110, housing 120, nozzle manifold 150 and one or more nozzles 160. The water connector 110 connects to external water supply via threads 112 and to the aspirating device 130. The housing 120 includes a gas port or hole 122. Nozzle 160 connects to nozzle intake 164 through a threaded connection 166. The nozzle 160 comprises two nozzles orifices 162. Housing 120 comprises aspirating device 130, fitted within housing 120. Aspirating device 130 includes six equally-spaced aspirating ports or holes 132 fitted along a circumference of the aspirating device 130. The aspirating device 130 is fitted with exterior upper threads 134 and lower threads 135. Adapter 140 connects with nozzle manifold 150 at upper end of adapter 140 and connects with aspirating device 130 at lower end of adapter 140. The aspirating device 130 is not directly attached to the housing 120. A void 128 is formed within the housing 120 and the aspirating device 130. Void 128 is partially defined by aspirating device exterior mid-surface area 136. The interior of aspirating device 130 is broadly that of a converging, straight, then diverging nozzle, and is referred to as an aspirating venturi. Water enters water atomization device 100 in the direction of the upward arrow of FIG. 1, and gas enters gas port 122 along the arrow shown adjacent to gas port 122. The gas enters gas port 122 and enters void 128 and one or more aspirating ports 132. The aspirating device 130 draws-in or suctions-in the supplied gas.

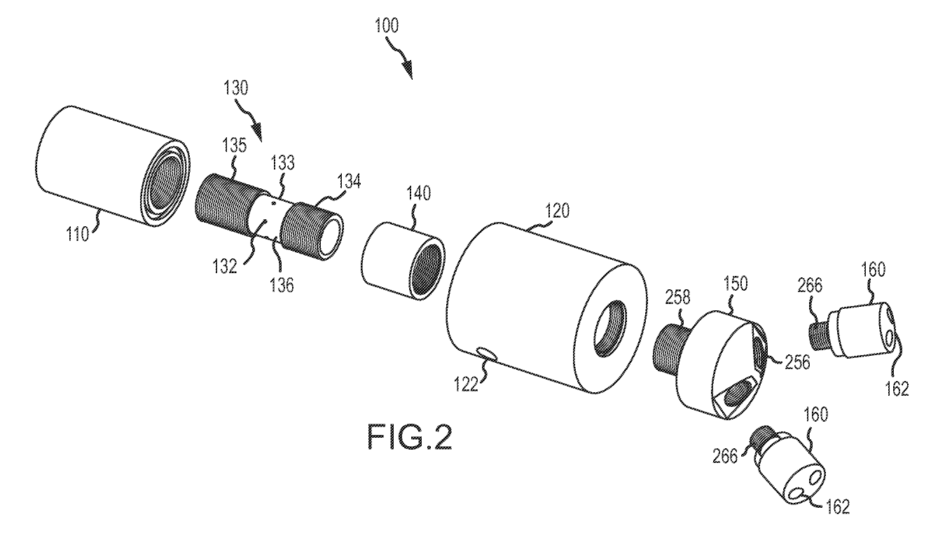

FIG. 2 depicts a disassembled view of the water atomization device 100 according to the first embodiment of FIGS. 1A-C. The water atomizer 100 includes a water connector 110 which fits via threads to a water source and fits to the aspirating device 130 via threads 135. Adapter 140 connects with nozzle manifold 150 at upper end of adapter 140 via threads 258 and connects with aspirating device 130 at lower end of adapter 140 via threads 134. The housing 120 includes a gas port 122 which connects with a gas supply line via threads (not shown). Two nozzles 160 connect to nozzle manifold 150 through a threaded connection 266. Each nozzle 160 comprise two nozzle orifices 162. Housing 120 comprises aspirating device 130, fitted within housing 120. Aspirating device 130 includes one or more aspirating ports 132 located along a circumference of aspirating device 130. A void 128 is formed within the housing 120 and the aspirating device 130.

In the embodiment of FIGS. 1A-C, 2 and 3A-C, the aspirating device 130 and nozzles 160 are contained within a common assembly defined by water connector 110, housing 120 and nozzle manifold 150. Also, the aspirating device 130 is an aspirating venturi (herein, with reference to the embodiment of FIGS. 1A-C, 2 and 3A-C, aspirating venturi and aspirating device are identical and referenced as element 130).

In this embodiment, the device 100 is used to generate fine water mist from water stored in a pressurized tank (connection via water connection 110) and gas stored under pressure (connection via inlet gas port 122). In the aspirating venturi 130, the water and gas are intimately mixed to form a two-phase effervescent flow upstream of the nozzle.

The aspirating venturi 130 comprises a central passageway 137 of smaller diameter than the exit diameter of the aspirating venturi 130. The water enters from the bottom of the venturi and the gas enters the throat of the venturi. With reference to FIG. 1C, the water enters in the direction of the upward arrow into water connection 110, and gas enters gas port 122 along the arrow shown adjacent to gas port 122. The gas enters gas port 122 and enters void 128 and enters one or more of the six aspirating ports 132. The gas fills the void 128. The gas is not directly fed to the aspirating venturi 130 but rather enters the venturi 130 via aspirating ports 132 in communication with the inside of the void 128. (It should be noted that in other embodiments of the device 100, a void 128 is not required, and the gas is fed directly into the venturi 130 via one or more aspirating ports 132). Water enters the venturi 130 directly from a tank (or reservoir) via water connector 110. The water and gas mix inside the venturi 130 substantially downstream of the gas ports 132 and thus generate a substantially atomized liquid and/or two phase mixture (gas/liquid) of the effervescent type. This mixture then flows to the nozzle manifold 150 and the nozzles 160 where it is discharged into the open space (which, in one application, is to be protected from fire). Upon exiting the nozzle 160, the substantially atomized mixture will fragment into small water droplets and form a water mist plume.

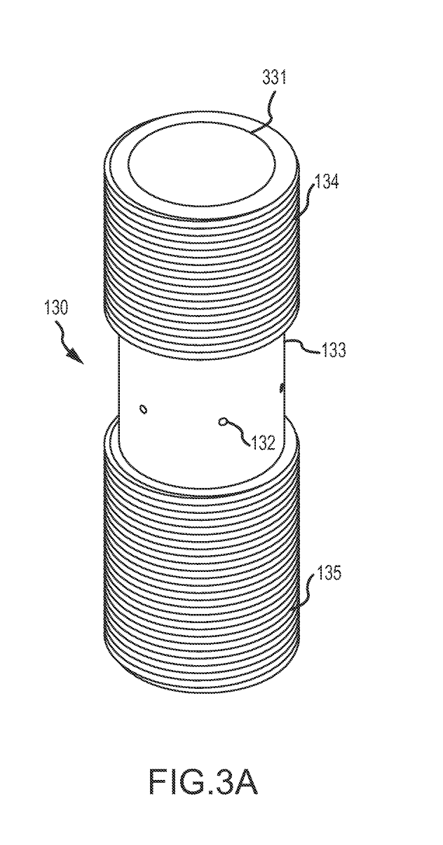

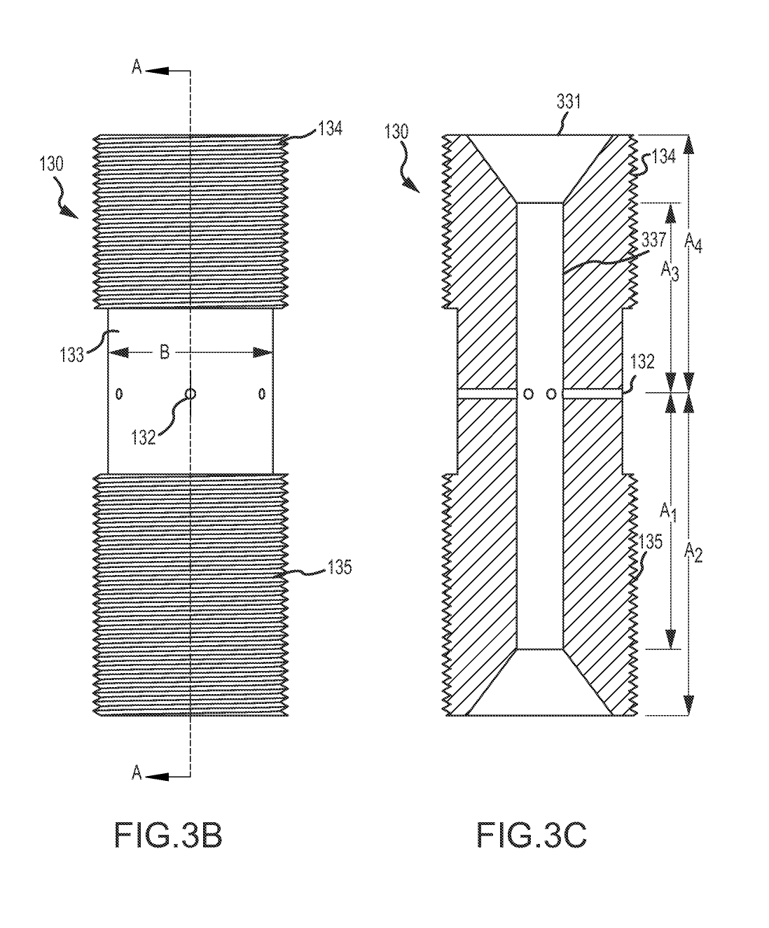

FIGS. 3A-C provide more detailed views of the aspirating venturi 130. Specifically, FIG. 3A is a perspective view of the aspirating venturi, FIG. 3B is a side view and FIG. 3C is a cross-sectional view taken along cut line A-A of FIG. 3B. Aspirating device 130 includes exterior center surface 133 and is fitted with exterior upper threads 134 and lower threads 135. Aspirating venturi 130 includes six aspirating ports 132 and comprises a central passageway 337 of smaller diameter than the exit diameter 331 of the aspirating venturi 130. Venturi characteristics are governed by, among other things, the gas and water passage diameters. Generally, the gas traveling though the nozzle will entrain (“push”) water droplets much further than could be achieved without this sort of “tail wind”. In typical prior art devices, due to the droplet small size, the water droplets usually lose their momentum very rapidly due to the drag force applied by the surrounding quiescent air. Aspirating venturi 130 has height from bottom to centerline of aspirating ports 132 of A₂, and height from top to centerline of aspirating ports A₄. Further, aspirating venturi 130 has internal distance from top of central passageway 337 to centerline of aspirating ports A₃, and internal distance from bottom of central passageway 337 to centerline of aspirating ports A₁.

Although FIGS. 1A-C, 2 and 3A-C provide an embodiment of the device 100 in which the aspirating device 130 is a venturi, other embodiments include those in which the aspirating device 130 is a tube of substantially uniform diameter in which one or more aspirating holes 132 are fitted to a circumference of the aspirating device 130.

Although FIGS. 1A-C, 2 and 3A-C provide an embodiment of the device 100 in which the aspirating device 130 includes six aspirating ports 132 located at equal radius points, that is every 60 deg, other embodiments provide other-than-six aspirating ports spaced in other configurations to include, but not limited to, a plurality of circumferences and slots rather than holes. The geometry of the one or more aspirating ports 132 is not limited to circles, but may be of any geometry known to those skilled in the art, to include, but not limited to, ellipses and rectangular slots.

Relative dimensions, areas and volumes of the one or more aspirating ports 132 relative to the central passageway 337, among other parameters, effect the performance of the aspirating venturi 130 and in turn the water atomizer device 100.

In one embodiment with reference to FIGS. 3A-C, the aspirating holes 132 are of diameter approximately 0.055 in and the cross-sectional diameter of the central passageway 337 is approximately 0.26 in, and/or the ratio of the diameter of an aspirating hole 132 to the central passageway 337 is approximately 0.21.

In one embodiment with reference to FIGS. 3A-C, the ratio of the diameter of an aspirating hole 132 to the central passageway 337 is preferably between about 0.1 and 3.0, more preferably between about 0.2 and 2.5, and most preferably between about 0.3 and 2.0.

In one embodiment with reference to FIGS. 3A-C, the diameter of the central passageway is no less than about 0.01 in.

In one embodiment with reference to FIGS. 3A-C, the total cross-sectional diameter of the six aspirating ports 132 relative to the cross-sectional diameter of the central passageway 337 is preferably between about 1.0 and 1.5, more preferably between about 1.1 and 0.4, and most preferably between about 1.2 and 1.3.

In one embodiment with reference to FIGS. 3A-C, the total cross-sectional area of the one or more aspirating ports 132 relative to the cross-sectional area of the central passageway 337 is preferably between about 0.005 and 0.80, more preferably between about 0.01 and 0.80, and most preferably between about 0.01 and 0.65.

In one embodiment with reference to FIGS. 3A-C, the distance A3 relative to the distance (A2+A4) is between about 0.1 and 0.5.

In one embodiment with reference to FIGS. 3A-C, the distance A3 relative to the distance A4 is between about 0.5 and 1.0.

In one embodiment with reference to FIGS. 3A-C, the individual cross-sectional diameters of the one or more aspirating ports 132 relative to the cross-sectional diameter of the central passageway 337 is preferably between about 0.001 and 0.20, more preferably between about 0.002 and 0.20, and most preferably between about 0.003 and 0.11.

Relative flow rates and pressures of the gas input and the water input, and associated dimensions, areas and volumes of the one or more aspirating ports 132 relative to the central passageway 337 and exit port 331 and/or entry port (not shown), among other parameters, effect the performance of the aspirating venturi 130 and in turn the water atomizer device 100.

In one embodiment, the gas pressure relative to the water pressure is preferably within about 20% of one another, more preferably within about 10% of one another, and most preferably within about 5% of one another.

In one embodiment, the gas pressure relative to the water pressure differs by no more than about 5%.

In one embodiment, the gas pressure ranges between about 100 and 900 psi, more preferably between 150 and 700 about psi, and most preferably between about 175 and 500 psi.

In one embodiment, the gas pressure is no lower than about 200 psi.

In one embodiment, the gas pressure is between about 300 and 400 psi.

In one embodiment, the water pressure ranges between about 100 and 900 psi, more preferably between about 150 and 700 PSI, and most preferably between about 175 and 500 psi.

In one embodiment, the water pressure is no lower than about 200 psi.

In one embodiment, the water pressure is between about 300 and 400 psi.

In one embodiment, the water atomization device is an intermediate pressure system. In one embodiment, the water atomization device produces a water mist. In one embodiment, the aspirating device and/or aspirating venturi produces a water mist. In one embodiment, atomized liquid is a fine water mist. In one embodiment, the aspirating device and/or aspirating venturi is an effervescent atomizer. In one embodiment, the liquid is water. In one embodiment, the gas is either nitrogen or carbon dioxide.

A variable to express the size distribution of the liquid droplets is the Sauter Mean Diameter (SMD). The SMD is the total volume of the liquid droplets divided by their total surface area. The SMD of the liquid droplets is preferably no more than about 300, more preferably no more than about 150, and even more preferably no more than about 80 microns.

The liquid can include additives to enhance the ability of the liquid droplets to suppress the exothermic reaction, such as free radical interceptors. A preferred free radical interceptor is an alkali metal salt, including potassium bicarbonate, potassium carbonate, sodium bicarbonate, sodium carbonate, and mixtures thereof. The free radical interceptor should have a concentration in the liquid ranging from about 1% up to saturation.

The liquid can include additives to decrease the freezing point of the liquid for applications at low temperatures. As will be appreciated, the freezing point of water is about 0 degrees Celsius, which is above the system temperature in many applications. The liquid can include such freezing-point depressants as glycerine, propylene glycol, diethylene glycol, ethylene glycol, calcium chloride, and mixtures thereof.

The liquid can include other additives to alter the surface tension of the liquid droplets. For example, wetting agents are effective because they decrease the surface tension of the liquid, resulting in the generation of smaller droplets and thus increasing the amount of free surface available for heat absorption. Suitable wetting agents include surfactants.

The liquid can include additives to decrease friction loss in the hoses and nozzle assembly. Linear polymers (polymers that are a single, straight-line chemical chain with no branches) are the most effective in reducing turbulent frictional losses. Poly(ethylene oxide) is an effective polymer for reducing turbulent frictional losses in the liquid.

The gas can be any suitable gas that is inert relative to the liquid and substantially immiscible in the liquid under the conditions of the water atomizing device and/or aspirating device. Suitable carrier gases include nitrogen, carbon dioxide, air, helium, argon, and mixtures thereof.

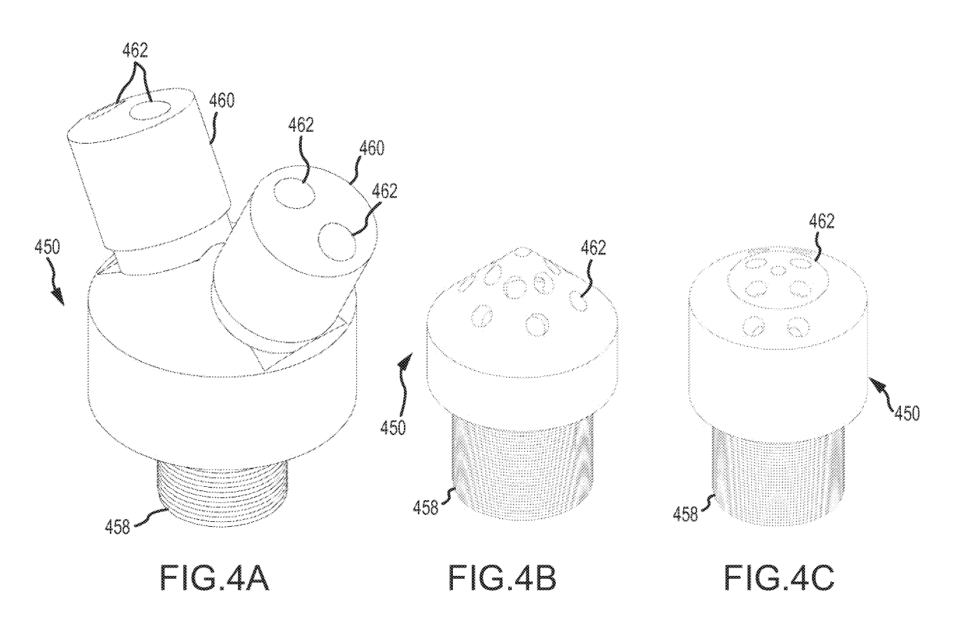

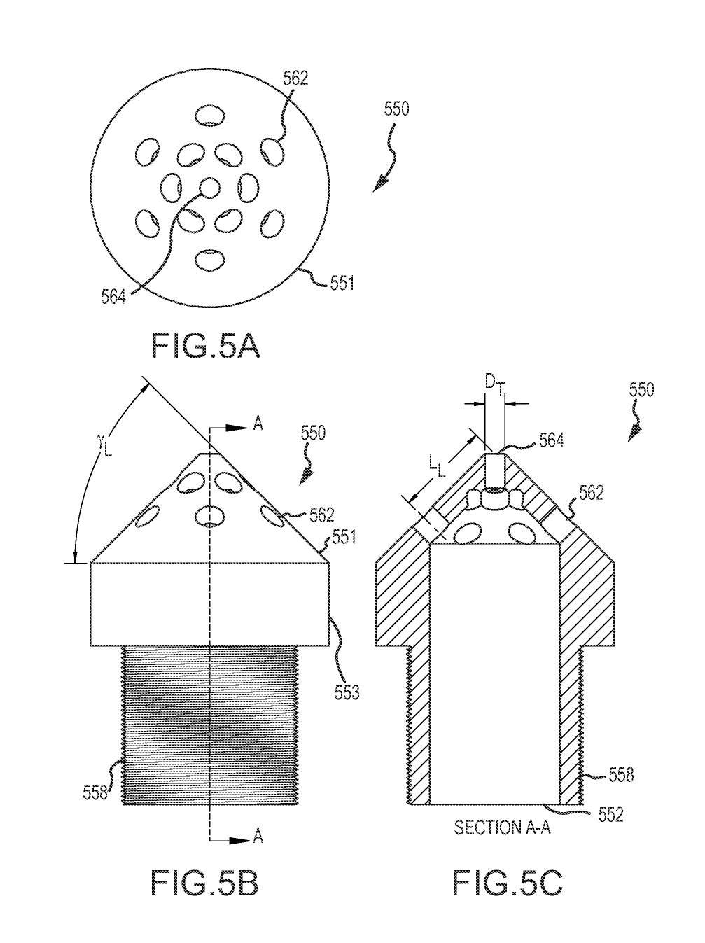

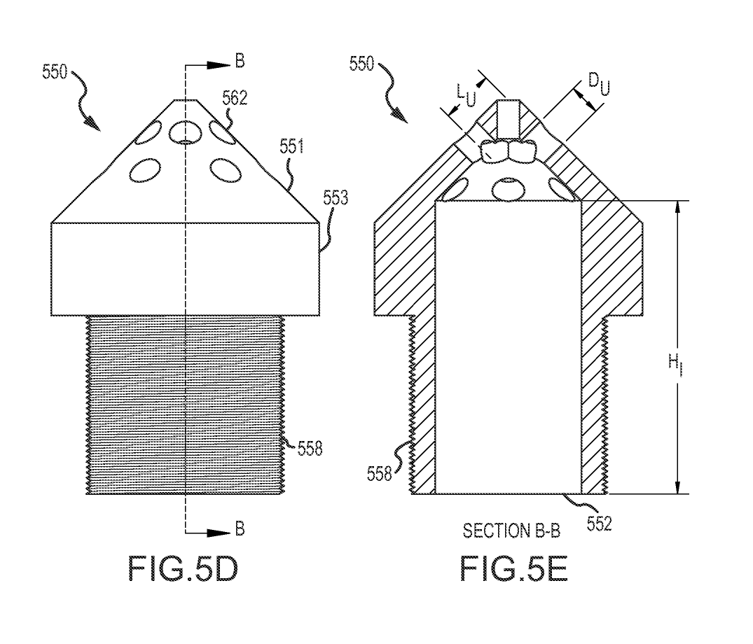

FIGS. 4A-C and 5A-E provide various embodiments of the nozzle assembly. FIGS. 4A-C provide perspective views of the nozzle assembly of the respective first, second and third embodiment. FIGS. 5A-E provide additional depictions of the nozzle assembly of the second embodiment of FIG. 4B. Generally, the nozzles of FIG. 4A and FIG. 4C are particularly useful for horizontal discharge and the nozzle of FIG. 4B and FIGS. 5A-E is particularly useful for overhead discharge.

With respect to FIGS. 4A-C, each nozzle assembly 450 embodiment comprises one or more nozzle orifices 462 and threaded connection 458 will enables connection to housing 120 (shown, for example, in FIGS. 2). The nozzle assembly 450 embodiment of FIG. 4A further includes two projected nozzles 460.

With respect to FIGS. 5A-E, nozzle assembly 550 is shown with thirteen exit orifices of two types: twelve lateral nozzle orifices 562 (which provide emissions containing a lateral component) and one vertical nozzle orifice 564 of diameter D_{T}. The nozzle 550 is configured with upper angled surface 551 at angle γ_{L}, vertical surface 553, exterior threads 558, bottom opening 552 and internal void of height H_{I}. The first circular ring of six lateral nozzle orifices 562 is spaced at a distance L_{U} from upper vertical nozzle orifice 564 and has diameter D_{U}. The second circular ring of six lateral nozzle orifices 562 is spaced at a distance L_{L} from upper vertical nozzle orifice 564 and had diameter D_{L} (not shown).

In one embodiment of the nozzle assembly 550 shown in FIGS. 5A-E, height H_{I} is approximately 1.64 in, γ_{L} is approximately 45 deg, threaded section 558 is approximately 1.0 in and bottom opening 552 is approximately 0.82 in, and diameter D_{U} and diameter D_{L} are approximately equal, and diameter D_{T} is approximately 0.7 times diameter D_{U}. Also, distance L_{L} is approximately 0.60 in and distance L_{U} is approximately 0.30 in. In other embodiments, the above referenced measures are not absolute but are applied relative to one another (as pairs or in any combination of at least two dimensions) to provide approximate ratios of relative dimensions.

In another embodiment of the nozzle assembly 550 shown in FIGS. 5A-E, diameter D_{U} and diameter D_{L} are approximately 0.18 in and diameter D_{T} is approximately 0.08 in. In other embodiments, the above referenced measures are not absolute but are applied relative to one another (as pairs or in any combination of at least two dimensions) to provide approximate ratios of relative dimensions.

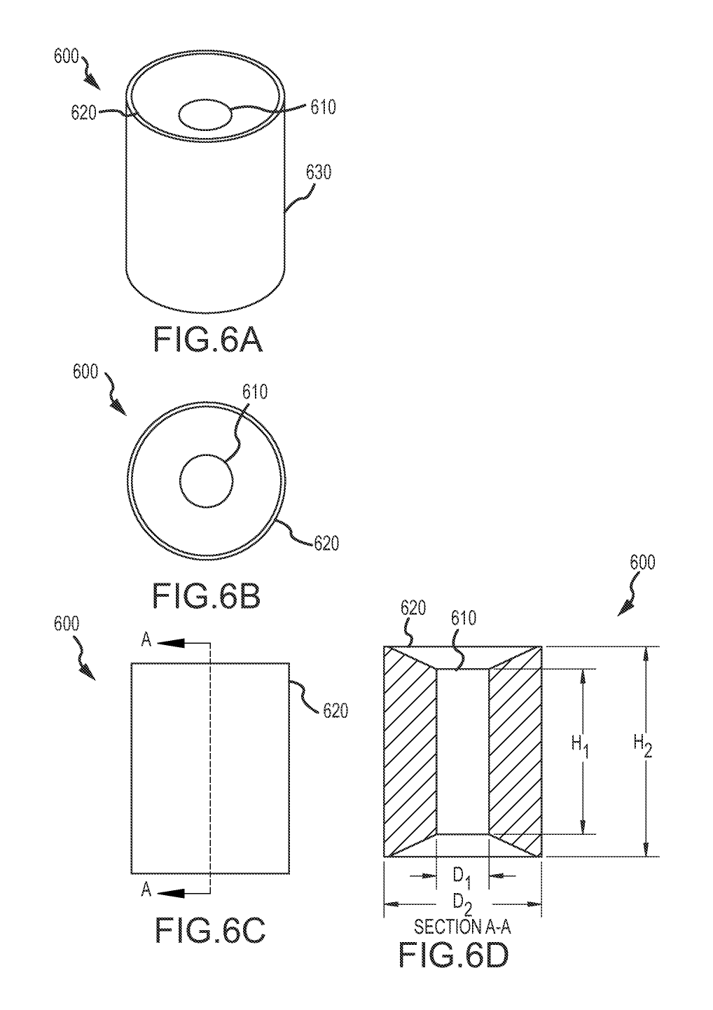

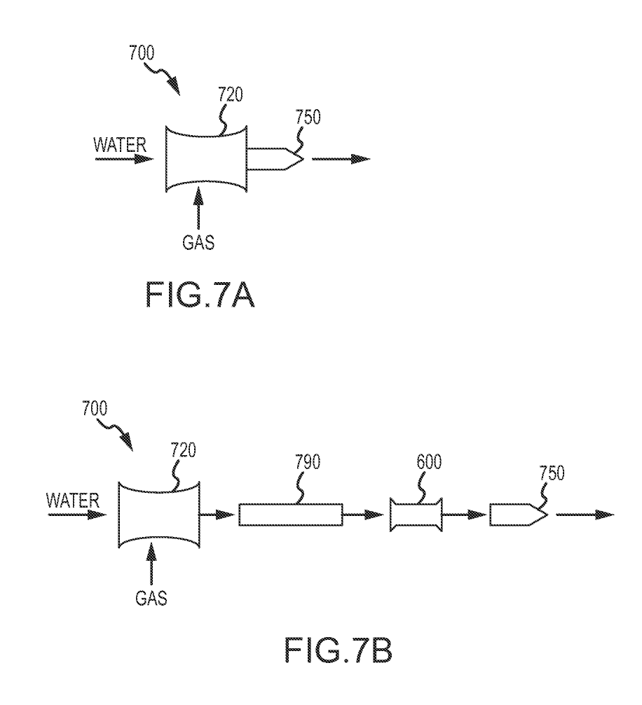

FIGS. 6A-D depict the remixing assembly of the fourth embodiment of the water atomization device of FIG. 7B. FIG. 7A provides a schematic of the water atomization device 700 according to the first embodiment (of FIGS. 1A-C, 2 and 3). FIG. 7A provides the device 700 with aspirating device 720 and nozzle 750 contained within a central housing, as described in FIGS. 1A-C, 2 and 3A-C. Also, the aspirating device 130 is depicted as an aspirating venturi. FIG. 7B provides a schematic of the water atomization device 700 according to a fourth embodiment. FIG. 7B provides the device 700 with aspirating device 720, carrier tube 790, re-mixer 600, and nozzle 750. In contrast to FIG. 7A, in this embodiment, the aspirating device 720 and nozzle 750 are not contained within a central housing. The aspirating device 720 depicted in FIG. 7B is an aspirating venturi.

FIGS. 6A-D depict the remixing assembly of the fourth embodiment of the water atomization device of FIG. 7B. Specifically, FIG. 6A is a perspective view of the remixing assembly, FIG. 6B a top view, FIG. 6C is a side view and FIG. 6D a cross-sectional view taken along cut line A-A of FIG. 6C.

A re-mixer is required in the embodiment of FIG. 7B because of the carrier tube 790, which, if of significant length, changes the state of the two-phase mixture output from the aspirating device. Specifically, the mixture may no longer be substantially atomized. As a solution, the re-mixer fits into the overhead nozzle assembly and re-atomizes the two-phase mixture before entry to the nozzle.

The fluid to be remixed, typically a 2-phase flow that is not fully atomized, enters at the lower end of re-mixer 600, entering through a diameter D₂. The fluid then enters an area of decreasing or converging diameter to a diameter of D₁. The fluid then travels through a central passage passageway 610 of length H₁, until it enters an area of increasing or diverging diameter D₂, therein exiting the re-mixer 600 at area 620. The length of re-mixer 600 is H₂. Re-mixer 600 has exterior surface 630.

In one embodiment of the re-mixer 600 shown in FIGS. 6A-D, diameter D₁ is approximately 0.25 in, diameter D₂ is approximately 0.75 in, length H₁ is approximately 0.79 in and length H₂ is approximately 1.0 in. In other embodiments, the above referenced measures are not absolute but are applied relative to one another (as pairs or in any combination of at least two dimensions) to provide approximate ratios of relative dimensions. With reference to FIG. 7B, the re-mixer 790 may engage the atomizing device 600 by any of several means, to include by threaded connection and interference fit.

The re-mixer was designed to re-atomize the water/gas mixture without imparting any (or insignificant) centrifugal forces. Assuming annular flow just before the re-mixer, the re-mixer directs the outer layer of liquid toward the center causing the gas and liquid to collide before exiting. During overhead discharge tests, the re-mixer of FIG. 6A-D eliminated any vibration present in the input line and produced a droplet size of about 122 μm (compared to 154 μm without the re-mixer).

Although several of the components of the device 100 have been described as connecting via threaded connections, one skilled in the art will appreciate that other connections are possible in other embodiments, to include but not limited to press fits, interference fits, magnetic fits, electrical fits, hydraulic fits, pneumatic fits and tongue and groove fits.

In one embodiment, the device 100 and/or components of the device 100 is engaged with a computer-readable medium and/or a processor.

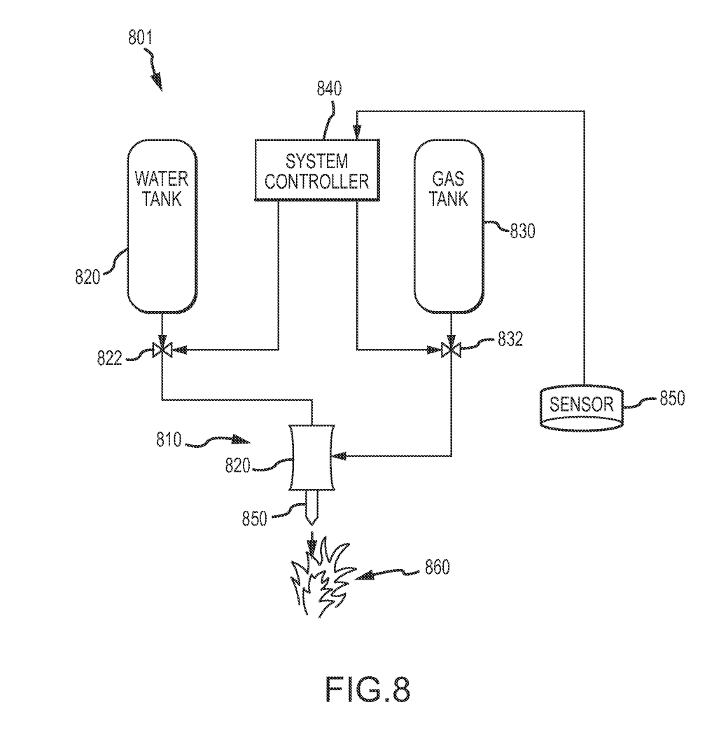

FIG. 8 provides a schematic of an exothermic event suppression system 801 employing the water atomization device 810 according to a fifth embodiment. The fire suppression system 801 comprises a water tank 820, gas tank 830, system controller 840, one or more exothermic event sensors 850, water tank valve 822, gas tank valve 832, and atomization device 810. The water atomization device 810 is depicted with aspirating device 820 and nozzle 850 contained within a central housing, as described in FIGS. 1A-C, 2 and 3A-C and FIG. 7A. However, the system 801 of FIG. 8 could also be implemented using the water atomization device 810 as configured in FIG. 7B. The fire suppression system 801 is used to automatically detect, through one or more sensors 850, an exothermic event 860. When the one or more sensors 850 detect an exothermic event 860, a signal is sent to system controller 840, which in turn opens water tank valve 822 and gas tank valve 832. The resulting supply of water and gas enter the atomization device 810 as described previously, generating a water mist which is directed, through nozzle 850, at the exothermic event 860. Although the exothermic event suppression system 801 is depicted containing all of these components, one or more components may be eliminated or combined in some applications and/or embodiments.

The one or more exothermic event sensors 850 (also referred to herein as “detectors”) may be of one or several types, such as thermal detectors, optical detectors to include photo-detectors, infrared, ultra-violet or any specific wavebands, motion detectors, hot-wire anemometers, or any detectors that may be used to detect an exothermic event. In embodiments of the disclosure, the detectors 850 may be omni-directional or directional, may be operated continuously or discontinuously, and may be configured as an array. Further, the detectors 850 may be digital or analog, and optionally require a power source. The detectors 850 are configured to be in communication with the system controller 840. This communication may be through electrical, electro-mechanical, hydraulic, pneumatic, thermal, radioactivity, ionization, photo detectors, or other communication means, and could be wireless. In a preferred embodiment, the detectors 850 provide an electrical signal to the system controller 840. In a preferred embodiment, the detectors 850 are configured to provide a complete field of view of the area to be protected. The system controller 840 is typically implemented as processor executable logic stored on a computer readable medium or media. In one embodiment, the exothermic event suppression system 801 further comprises is a computer-readable medium and/or a processor.

Although the water atomization device has been discussed for use, among others, in fire suppression, other applications are known to those skilled in the art, to include, but not limited to, water evaporation, fuel combustion, humidifiers, snow making, powder metal fabrication and fire protection.

### EXPERIMENTAL

Various tests were performed to determine the efficacy of the water atomizing device, aspirating venturi, various nozzles, and re-mixer.

Eight aspirating venturis were developed and evaluated ranging in flow rate from 10 to 45 gpm. Table 1 presents each venturi's identification label (e.g. “FV1”) and design specifications based on the results of the laboratory tests performed.

Table 1 shows that the carbon dioxide propellant was nominally quicker to extinguish test fires in all tests. The tests were run at a starting pressure of 850 psi in a single storage container, which represents the condition where the CO₂ propellant will be present in the storage tank in both the gas and liquid phases. In Table 1, with reference to FIGS. 3A-C, gas passage diameter equates to aspirating ports (six in total) 132 and water passage diameter equates to central passageway 337 of the aspirating venturi 130.

TABLE 1
Extinguishment times for carbon dioxide and nitrogen propellant systems.
Table 1. List of Venturis and Specifications

| | Water Passage | Gas Passage | Discharge | |
|---|---|---|---|---|
| Venturi | Diameter-D_{w} | Diameter-D_{g} | Time | Flow Rate |
| Name | (in) | (in) | (seconds) | (gpm) |
| FV1 | 0.63 | 0.065 | 80 | 45 |
| FV2 | 0.50 | 0.052 | 140 | 26 |
| FV3 | 0.42 | 0.043 | 155 | 23 |
| FV4 | 0.29 | 0.034 | 240 | 15 |
| FV5 | 0.29 | 0.040 | 180 | 20 |
| FV6 | 0.20 | 0.040 | 360 | 10 |
| FV7 | 0.23 | 0.047 | N/A | N/A |
| FV8 | 0.26 | 0.055 | 255 | 14 |

Various tests were also performed to evaluate configurations of the water atomization device 700 according to the first embodiment (of FIGS. 1A-C, 2 and 3), as provided schematically in FIG. 7A. In the tested embodiment, two N₂ sources and two pneumatic actuators controlling three valves to discharge the water atomization device 700 were employed. In this configuration, one N₂ cylinder (A) supplied the water tank using a high pressure regulator (r1). Another cylinder (B) supplied both the nozzle assembly using a high pressure regulator and the two pneumatic actuators controlling three valves: the N₂ supply to the water tank (v1), the N₂ supply to the nozzle (v2), and the water supply to the nozzle (v3). The pneumatic actuator supply used a low pressure regulator (r3) because the pneumatic valves only required 150 psi to operate. The pneumatic valves were controlled by a solenoid valve (v4) installed after the regulator (r3) that remained closed until power was supplied to it. The supply line then split to supply the two pneumatic actuators with the 150 psi gas required to open each valve. A ball valve (b1) was located between the actuator for valves (v2 and v3) and the 150 psi supply line. In the closed position, this ball valve allowed the pneumatic tank valve (v1) to open while keeping the supply valves (v2 and v3) closed by blocking the gas required to open these valves when power was supplied to the solenoid valve (s1). It was necessary to keep the water supply valve (v3) closed while pressurizing the tank because otherwise the water in the tank would flow out of the nozzle as gas entered the tank and pressure would not build up. After pressurizing the tank to 400 psi, the power to the unit was turned off and the ball valve was opened so that all three pneumatic valves (v1, v2, and v3) would open when power was supplied to the unit for discharge.

In this configuration, the pneumatic valve (v1) between cylinder (A) and the water tank was required so the tank could be pressurized to 400 psi (v1 open) prior to discharge and the supply pressure could then be set to 1300 psi without increasing the tank pressure (v1 closed). This ‘over-pressurization’ of cylinder (A) was required in order to supply enough gas to the tank during discharge to maintain 400 psi in the tank using the high pressure regulator (r1). During the full scale fire testing, we found that high flow TESCOM™ regulators enable the tank pressure to be maintained at 400 psi during discharge with an equivalent supply pressure. With a high flow regulator, the N₂ supply to the tank never needs to be closed since the supply pressure can be set to 400 psi to pressurize the tank and does not need to be increased for discharge. As a result, the pneumatic valve on the tank (v1) and the ball valve on the 150 psi supply line (b1) are not required when a high flow regulator is used on cylinder (A). The remaining components include one ball valve for filling the tank with water (b2), one ball valve (b3) for venting the tank while filling it with water, a pressure relief valve to ensure the tank pressure does not exceed 500 psi, a pressure gauge giving the tank pressure, and two pressure transducer inputs for measuring the pressure in the tank and at the nozzle during laboratory tests. N₂ is supplied to the nozzle at approximately 400 psi.

In order to supply two nozzles with 1.27 L/s (20 gpm) of FWM each for 10 min, four 417-L tanks and 16 N₂ bottles would be required. This totals to twelve 417-L tanks and 48 N₂ bottles for the entire six nozzle system to run for 10 min continuously. While all these tanks and cylinders would take up excessive space they could be stored outside and piped into the building. Also, the amount of space taken up could be dramatically reduced by replacing the water tanks from each unit with a high flow water pump. A water pump capable of supplying 2.53 L/s (40 gpm) of water at 3.45 MPa (500 psi) costs roughly the same amount as two water tanks and could potentially supply two nozzles with 1.27 L/s (20 gpm) each indefinitely. Implementing this pump would also cut the number of required N₂ cylinders in half since there would be no water tank to pressurize. It was found that each nozzle discharges at least an average of 1.27 L/s (20 gpm), a minimum pressure of roughly 1.72 MPa (250 psi) is required to maintain FWM atomization, and 4.14 MPa (600 psi) TESCOM™ regulators should be used to supply the tank and the nozzle to generate a constant pressure in the nozzle. One system configuration of consists of at least six nozzles: two overhead nozzles (of the type of FIG. 4B) and four horizontal nozzles (of the type of FIG. 4A).

In one embodiment evaluated, the gas-to-liquid ratio delivered to the nozzle assembly was maintained at approximately 5 percent. Water flow rate out of the water tank depends on the venturi used in the nozzle assembly: the main venturis developed deliver an average 10 gpm and 20 gpm of water, requiring an N₂ flow rate of 53.4 scfm and 106.8 scfm respectively. At the end of the FWM discharge, the N₂ bottle and the water tank are filled with N₂ at roughly 400 psi.

In one embodiment evaluated, an orientation of overhead nozzles at a 45° angle aiming toward the center of the protection area substantially increased the suppression capabilities of the FWM system, and a height of 24 ft was adequate to prevent fire damage to the nozzles.

In another embodiment evaluated, the aspirating venturi supplied at least 40 gpm of two-phase flow and a venturi mixer was used with each nozzle. Each unit operates at 500 psi in order to supply each nozzle with a minimum of 250 psi. FWM is achieved at 250 psi, but if higher pressure is desired, then single nozzle units may be used with 20 gpm venturis. The number of water tanks and N₂ cylinders used depends on the desired discharge time. With one 110-gal tank and four N₂ cylinders supplying two nozzles with 20 gpm each, the unit will discharge for approximately 2.5 min. Doubling the number of tanks and cylinders on a unit will double the discharge time and so forth.

In one embodiment evaluated, one-square meter pan fires could be consistently extinguished by two FWM units as long as the nozzles are positioned no further than 8.2 m (27 ft) from the fire. Each nozzle discharged at least an average of 1.27 L/s (20 gpm). A minimum pressure of roughly 1.72 MPa (250 psi) was required to maintain FWM atomization. Also, 4.14 MPa (600 psi) TESCOM™ regulators should be used to supply the tank and the nozzle to generate a constant pressure in the nozzle.

In one embodiment evaluated, in order to supply two nozzles with 1.27 L/s (20 gpm) of FWM each for 10 min, four 417-L tanks and 16 N₂ bottles are required. This totals to twelve 417-L tanks and 48 N₂ bottles for the entire six nozzle system to run for 10 min continuously. While all these tanks and cylinders would take up excessive space they could be stored outside and piped into a building. Also, the amount of space taken up could be dramatically reduced by replacing the water tanks from each unit with a high flow water pump. A water pump capable of supplying 2.53 L/s (40 gpm) of water at 3.45 MPa (500 psi) costs roughly the same amount as two water tanks and could potentially supply two nozzles with 1.27 L/s (20 gpm) each indefinitely. Implementing this pump would also cut the number of required N₂ cylinders in half since there would be no water tank to pressurize.

A number of variations and modifications of the disclosure can be used. It would be possible to provide for some features without providing others.

The present disclosure, in various embodiments, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features are grouped together in one or more embodiments for the purpose of streamlining the disclosure. The features of the embodiments may be combined in alternate embodiments other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment.

Moreover, though the description has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A liquid atomization system, comprising:
(a) an aspirating device configured to receive a liquid and a gas, the liquid passing through a central passageway of the aspirating device and the gas entering the central passageway through one or more ports in the central passageway, wherein the liquid and gas are mixed to form an atomized liquid upon exit from the aspirating device; and
(b) a nozzle configured with one or more orifices, the nozzle in downstream communication with the aspirating device and configured to receive the atomized liquid, wherein the nozzle is configured to direct the atomized liquid through the one or more orifices to the exterior of the nozzle.

2. The system of claim 1, wherein the aspirating device is an aspirating venturi.

3. The system of claim 2, wherein the aspirating venturi comprises a central passageway of smaller diameter than an exit diameter of the aspirating venturi.

4. The system of claim 2, wherein the liquid flows through a throat of the venturi and the gas enters the throat of the venturi.

5. The system of claim 1, wherein the liquid comprises water.

6. The system of claim 5, wherein the gas comprises at least one of nitrogen and carbon dioxide.

7. The system of claim 1, wherein the atomized liquid is a fine water mist.

8. The system of claim 1, wherein downstream of the aspirating device and upstream of the nozzle, the system further comprises a carrier tube configured to receive the atomized liquid from the aspirating device, wherein upon exit from the carrier tube the atomized liquid is a partially atomized liquid, and a re-mixer configured to receive the partially atomized liquid, wherein upon exit from the re-mixer the partially atomized liquid is an atomized liquid supplied to the nozzle.

9. The system of claim 1, wherein the atomized liquid forms droplets with a Sauter Mean Diameter of no more than about 80.

10. The system of claim 1, wherein the nozzle directs the atomized liquid in a direction of an exothermic reaction.

11. The system of claim 10, wherein the exothermic reaction is at least one of a fire and deflagration.

12. A system, comprising:
a gas input to receive a gas from a gas source;
a liquid input to receive a liquid from a liquid source;
a sensor operable top detect a thermal event;
a controller operable to cause discharge of the gas through the gas source and liquid through the liquid source;
an aspirating device configured to receive a liquid and a gas, the liquid passing through a central passageway of the aspirating device and the gas entering the central passageway through one or more ports in the central passageway, wherein the liquid and gas are mixed to form an atomized liquid upon exit from the aspirating device; and
a nozzle configured with one or more orifices, the nozzle in downstream communication with the aspirating device and configured to receive the atomized liquid, wherein the nozzle is configured to direct the atomized liquid through the one or more orifices to the exterior of the nozzle.

13. The system of claim 12, wherein the aspirating device is an aspirating venturi.

14. The system of claim 13, wherein the aspirating venturi comprises a central passageway of smaller diameter than an exit diameter of the aspirating venturi.

15. The system of claim 13, wherein the liquid flows through a throat of the venturi and the gas enters the throat of the venturi.

16. The system of claim 12, wherein the liquid comprises water.

17. The system of claim 16, wherein the gas comprises at least one of nitrogen and carbon dioxide.

18. The system of claim 12, wherein downstream of the aspirating device and upstream of the nozzle, the system further comprises a carrier tube configured to receive the atomized liquid from the aspirating device, wherein upon exit from the carrier tube the atomized liquid is a partially atomized liquid, and a re-mixer configured to receive the partially atomized liquid, wherein upon exit from the re-mixer the partially atomized liquid is an atomized liquid supplied to the nozzle.

19. The system of claim 12, wherein the nozzle directs the atomized liquid in a direction of an exothermic reaction.

20. A method, comprising:
(a) providing an aspirating device configured to receive a liquid and a gas, the liquid passing through a central passageway of the aspirating device and the gas entering the central passageway through one or more ports in the central passageway, wherein the liquid and gas are mixed to form an atomized liquid upon exit from the aspirating device, a nozzle configured with one or more orifices, the nozzle in communication with the aspirating device and configured to receive the atomized liquid; and
(b) discharging the atomized liquid through the one or more orifices of the nozzle in proximity to an exothermic event, whereby the exothermic event is suppressed.
